(19) United States
(12) Patent Application Publication
(10) Pub. No.: US 2026/0336079 A1
(43) Pub. Date: Oct. 29, 2026

(54) Driving-in apparatus

(71) Applicant: Hilti Aktiengesellschaft, Schaan (LI)

(72) Inventors: Emanuel KURTH, Chur (CH); Ulrich ROSENBAUM, Wangs (CH)

(21) Appl. No.: 19/491,182

(22) PCT Filed: Jun. 13, 2024
(86) PCT No.: PCT/EP2024/066364

§ 371 Date: Dec. 8, 2025

(30) Foreign Application Priority Data
Jul. 5, 2023 (EP) 23183503.4

(51) Int. Cl. B25C 1/04; B25C 1/06

(52) U.S. Cl. CPC B25C 1/047; B25C 1/06

(57) ABSTRACT

A tool for driving a fastening element into a substrate, the tool comprising a spring and a driving element, the tool also comprising a loading unit having a rotary drive, a rotary element and a tension element. The traction element is attached to the driving element and can be wound up to convey the driving element from a setting position into an initial position.

### BACKGROUND

It is known in apparatuses of this type to temporarily store mechanical energy in a mechanical energy store and to transmit said energy abruptly to a fastening element. For this purpose, use is conventionally made of an energy transmission element, for example in the form of a piston, which is arranged in a driving-in direction between the mechanical energy store and the fastening element and which moves back and forth. Such apparatuses therefore have relatively large dimensions in the driving-in direction. In some fields of use, it is desirable to provide an apparatus in which these dimensions are reduced. To move the energy transmission element back, toothed wheels are known which mesh with the energy transmission element, which for this purpose is in the form of a toothed rack. In some fields of use, it is desirable to provide an apparatus which exhibits high mechanical robustness.

### SUMMARY OF THE INVENTION

It is an object of the present invention to provide an apparatus for driving a fastening element into a substrate, comprising a spring for storing mechanical energy and a driving-in element that is movable from an initial position into a setting position in order to transmit energy from the spring to the fastening element in a driving-in direction, and furthermore comprising a tensioning apparatus for tensioning the spring, wherein the tensioning apparatus has a rotary drive, a rotary element that is driven in rotation by the rotary drive, and a flexible traction element, wherein the traction element has a front end attached to the driving-in element and a rear end attached to the rotary element, and wherein the tensioning apparatus is provided for winding up the traction element in order to convey the driving-in element from the setting position into the initial position. The spring is preferably tensioned by virtue of the driving-in element being conveyed from the setting position into the initial position. Since the driving-in element is moved by means of the traction element, the rest of the driving-in element can be provided in a mechanically robust form, for example a circular cylindrical form. The tension element preferably comprises a belt or a cable.

The present invention provides that the spring has a gas spring and the driving-in element has a piston that delimits a gas volume of the gas spring, wherein the gas spring is compressed by virtue of the driving-in element being conveyed from the setting position into the initial position. It is preferable if the rotary drive, the rotary element and/or the traction element is arranged partially or entirely in the gas spring. A further advantageous embodiment is characterized in that the rotary drive comprises an electric motor and/or an electrical battery. A further advantageous embodiment is characterized in that the rotary element comprises a spool or drum for winding up the traction element.

The present invention also provides that the tensioning apparatus has a coupling that acts between the rotary drive and the rotary element, which coupling is preferably arranged partially or entirely in the gas spring. The coupling preferably comprises a wrap spring coupling. The coupling likewise preferably comprises a claw coupling. The rotary element particularly preferably comprises one or more claws of the claw coupling.

### BRIEF DESCRIPTION OF THE DRAWINGS

Embodiments of an apparatus for driving a fastening element into a substrate will be explained in more detail in the following text on the basis of examples and with reference to the drawings. In the drawings:

FIG. 1 shows a side view of a driving-in apparatus,

FIG. 2 is a schematic illustration of a driving-in apparatus,

FIG. 3 is a further schematic illustration of the driving-in apparatus of FIG. 2,

FIG. 4 is a further schematic illustration of the driving-in apparatus of FIG. 2, and

FIG. 5 is a further schematic illustration of the driving-in apparatus of FIG. 2.

### DETAILED DESCRIPTION

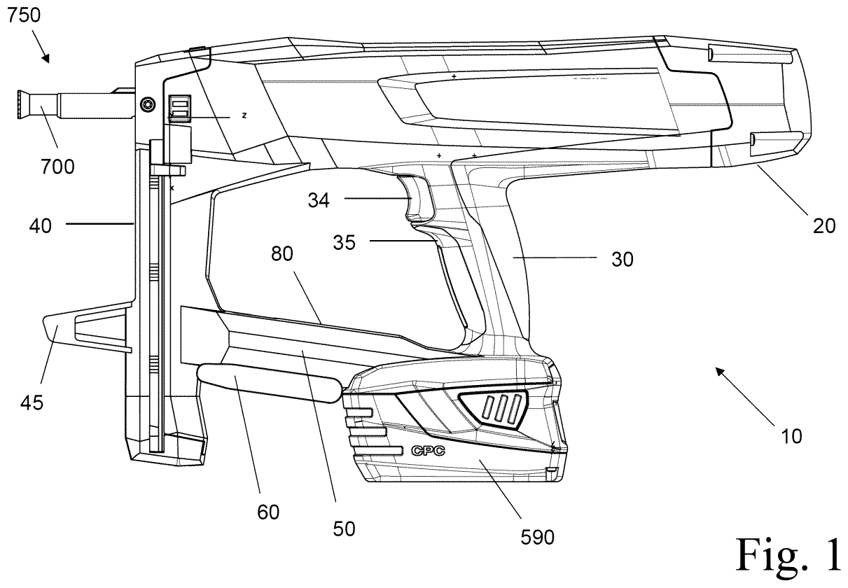

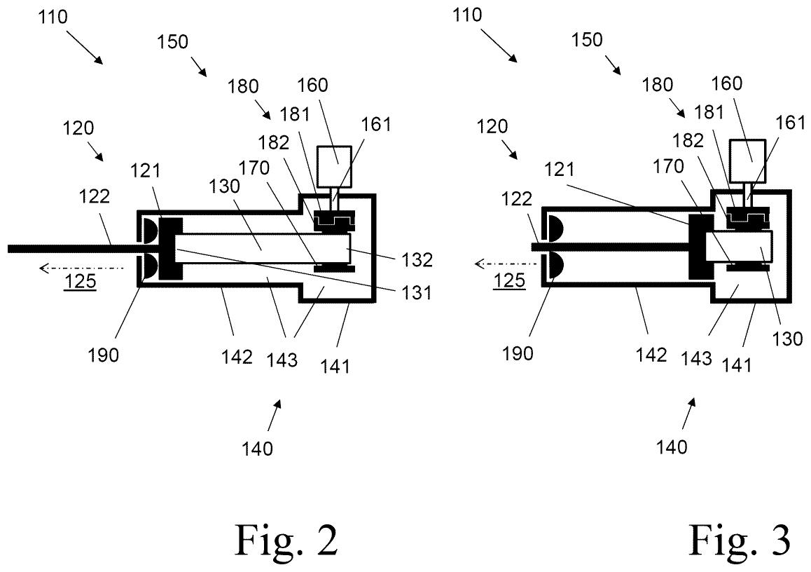

FIG. 1 shows, in a side view, a driving-in apparatus 10 for driving a fastening element, for example a nail or bolt, into a substrate. The driving-in apparatus 10 has a driving-in element 120 (see e.g., FIG. 2) for transmitting energy from a spring 140 (see e.g., FIG. 2) to the fastening element, and has a housing 20 in which the driving-in element 120 and a tensioning apparatus 150 (see e.g., FIG. 2) for conveying the driving-in element 120 are accommodated.

The driving-in apparatus 10 also has a handle 30, a magazine 40 and a bridge 50 connecting the handle 30 to the magazine 40. Attached to the bridge 50 are a scaffold hook 60 for suspending the driving-in apparatus 10 on a scaffold or the like, and an electrical energy store in the form of an electrical storage battery 590. Arranged on the handle 30 are a trigger 34 and a grip sensor in the form of a manual switch 35. Furthermore, the driving-in apparatus 10 has a guide channel 700 for guiding the fastening element and has a pressing device 750 for detecting a distance of the driving-in apparatus 10 from a substrate. Alignment of the driving-in apparatus 110 perpendicularly to a substrate is assisted by an alignment aid 45.

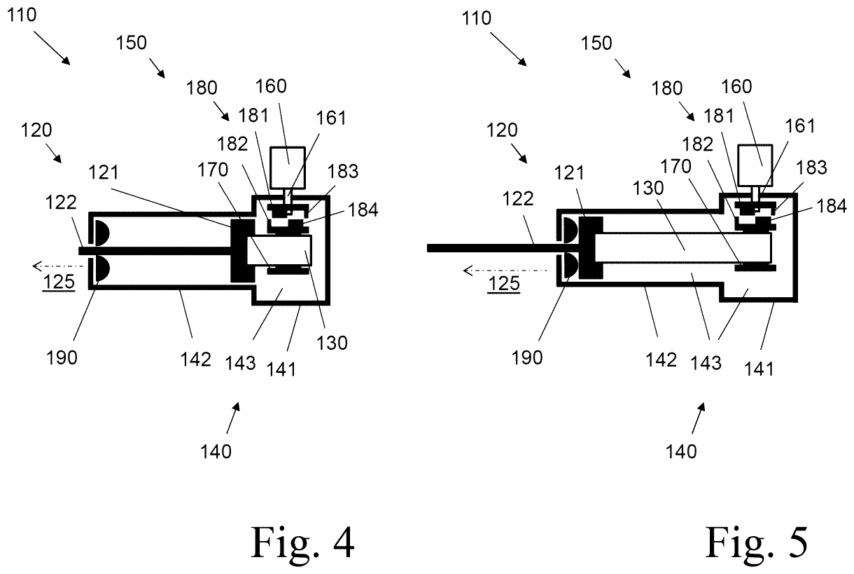

FIG. 2 to 5 schematically illustrate a driving-in apparatus 110 having a driving-in element 120, having a spring 140 and having a tensioning apparatus 150 for conveying the driving-in element 120. The driving-in element 120 comprises a piston 121, which is movable back and forth in a cylindrical, preferably circular cylindrical, portion 142 of a spring housing 141, and a driving-in rod 122, which is provided for impacting against a fastening element in order to drive the fastening element into a substrate. The spring 140 serves for storing mechanical energy that is transmitted by the driving-in element 120 to the fastening element when the driving-in element 120 is moved in a driving-in direction 125 from an initial position (see e.g., FIG. 4) into a setting position (see e.g., FIG. 5). The spring 140 is in the form of a gas spring having a gas volume 143, wherein the gas volume 143 is delimited by the spring housing 141 and the piston 121. This allows the spring 140 to be compressed by virtue of the driving-in element 120 being conveyed from the setting position into the initial position.

The tensioning apparatus 150 comprises an electrical battery, for example the electrical storage battery 590 in FIG. 1, a rotary drive 160 in the form of an electric motor having a transmission, a rotary element 170 that is driven in rotation by the rotary drive 160 and is in the form a spool or drum, a traction element 130, and a coupling 180. The rotary element 170, the coupling 180 and the traction element 130 are arranged entirely in the gas volume 143 of the spring 140. The rotary drive is arranged outside the gas volume 143 and transmits rotational energy to the rotary element 170 by means of a rotary shaft 161, which is led through the spring housing 141 and sealed off, and by means of the coupling 180. The flexible traction element 130 is in the form of a belt or cable and has a front end 131, which is attached, preferably fastened, to the piston 121 of the driving-in element, and a rear end 132, which is attached, preferably fastened, to the rotary element 170.

The coupling 180 acts between the rotary drive 160 and the rotary element 170 such that said coupling 180, in a closed state, connects the rotary drive 160 rotationally conjointly to the rotary element 170 and, in an opened state, allows the rotary drive 160 and the rotary element 170 to rotate freely relative to one another. For this purpose, the coupling 180 comprises a first cam disk 181, having first claws 183 in the form of cams, and a second cam disk 182, having second claws 184 in the form of cams. The first cam disk 181 and thus the first claws 183 are connected rotationally conjointly to the rotary drive 160. The second cam disk 182 and thus the second claws 184 are connected rotationally conjointly to the rotary element 170. In the closed state of the coupling 180 (see e.g., FIGS. 2 and 3), the first claws 183 engage form-fittingly with the second claws 184 in the circumferential direction, such that a rotational movement is transmitted from the rotary drive 160 to the rotary element 170 and vice versa.

In the opened state of the coupling 180 (see e.g., FIGS. 4 and 5), the first claws 183 disengage from the second claws 184 in the circumferential direction, such that no rotational movement is transmitted from the rotary drive 160 to the rotary element 170 or vice versa. In particular, the second cam disk 182 is a part of the rotary element 170, such that the rotary element 170 comprises the second claws 184. In exemplary embodiments, the coupling is in the form of a wrap spring coupling.

The tensioning apparatus 150 is provided for winding up the traction element 130 on the rotary element 170 in order to convey the driving-in element 120 from the setting position into the initial position. For this purpose, with the coupling 180 closed, the rotary element 170 is driven in rotation by the rotary drive 160. The piston 121 and thus the driving-in element 120 is thus conveyed from the setting position (see e.g., FIG. 2) into the initial position (see e.g., FIG. 3) counter to the driving-in direction 125, such that the gas volume 143 is reduced in size and the spring 140 is tensioned. In the process, the traction element 130 is wound onto the rotary element 170. The rotary drive 160 or the rotary shaft 161 is advantageously equipped with a freewheel mechanism, such that the rotary element 170 is held in the position illustrated in FIG. 3 by means of the coupling 180.

When a trigger switch, for example the trigger 34 in FIG. 1, is actuated, the coupling 180 is opened, whereby the driving-in element 120, driven by the spring 140, is accelerated in the driving-in direction 125 from the initial position (see e.g., FIG. 4) into the setting position (see e.g., FIG. 5). In the process, the driving-in element 120 pulls the traction element 130, at its front end 131, conjointly in the driving-in direction 125, such that the traction element 130 is unwound from the rotary element 170. In the setting position, the driving-in element 120 impacts against the fastening element and/or a buffer 190 of the driving-in apparatus, which has an elastic material, for example an elastomer. The driving-in apparatus 110 is then ready, by virtue of the coupling 180 being closed, to move back into the state shown in FIG. 2 and subsequently convey the driving-in element 120 back into the initial position and tension the spring 140.

The invention has been explained above on the basis of a number of exemplary embodiments of a driving-in apparatus. The features described can be transferred individually or in combination from each exemplary embodiment to all other exemplary embodiments as long as they do not contradict one another. It should be noted that the apparatus according to the invention can also be used for other purposes.

What is claimed is:

1-12. (canceled)

13. An apparatus for driving a fastening element into a substrate, the apparatus comprising:
a spring for storing mechanical energy;
a driving-in element movable from an initial position into a setting position in order to transmit energy from the spring to the fastening element in a driving-in direction;
a tensioning apparatus for tensioning the spring, wherein the tensioning apparatus has a rotary drive, a rotary element driven in rotation by the rotary drive, and a flexible traction element, wherein the traction element has a front end attached to the driving-in element and a rear end attached to the rotary element, and wherein the tensioning apparatus is provided for winding up the traction element on the rotary element in order to convey the driving-in element from the setting position into the initial position.

14. The apparatus as recited in claim 13 wherein the spring is tensioned by the driving-in element being conveyed from the setting position into the initial position.

15. The apparatus as recited in claim 14 wherein the spring has a gas spring and the driving-in element has a piston delimiting a gas volume of the gas spring, and wherein the gas spring is compressed by virtue of the driving-in element being conveyed from the setting position into the initial position.

16. The apparatus as recited in claim 15 wherein the rotary drive, the rotary element or the traction element is arranged partially or entirely in the gas spring.

17. The apparatus as recited in claim 13 wherein the tensioning apparatus has a coupling acting between the rotary drive and the rotary element.

18. The apparatus as recited in claim 17 wherein the coupling includes a wrap spring coupling.

19. The apparatus as claimed in claim 17 wherein the coupling includes a claw coupling.

20. The apparatus as claimed in claim 19 wherein the rotary element includes one or more claws of the claw coupling.

21. The apparatus as recited in claim 17 wherein the coupling is arranged partially or entirely in the gas spring.

22. The apparatus as recited in claim 13 wherein the traction element includes a belt or a cable.

23. The apparatus as recited in claim 13 wherein in the rotary drive includes an electric motor or an electrical battery.

24. The apparatus as recited in claim 13 wherein the rotary element comprises a spool or drum for winding up the traction element.
